(19) United States
(12) Patent Application Publication
(10) Pub. No.: US 2017/0103442 A1
(43) Pub. Date: Apr. 13, 2017

(54) EPIC TRIP EXPERIENCE APPLICATION

(71) Applicant: Kimberli Cheung Wright, Palo Alto, CA (US)

(72) Inventor: Kimberli Cheung Wright, Palo Alto, CA (US)

(21) Appl. No.: 15/292,025

(22) Filed: Oct. 12, 2016

Related U.S. Application Data
(60) Provisional application No. 62/240,383, filed on Oct. 12, 2015.

(51) Int. Cl. G06Q 30/06; G06F 3/0484; G06F 3/0482; H04L 29/08

(52) U.S. Cl. CPC G06Q 30/0631; G06Q 30/0641; H04L 67/306; G06F 3/04847; G06F 3/0482; G06F 3/04883

(57) ABSTRACT

A visual exploration system presents one or more interfaces for selection and purchase of one or more travel packages. Using the presented interfaces, a user may input his or her preferences and may also select one or more travel exploration representations (“TERS”). Based on the selected TERs, the disclosed system may present a refined set of TERs, or may present suggested travel packages or travel package components for purchase, or about which additional information may be requested. The disclosed system may rank and/or weight the presented TERs and travel packages. The disclosed system may further include other types of purchase exploration representations to find application in other types of purchases, such as real estate, interior design, fashion, and auto sales.

### BACKGROUND

Travel allows one to learn more about the world, transforming attitudes and perspectives for the better, both personally and in the lives of loved ones. Whether the focus is on exploration, humanitarian service, or simply finding a much needed quiet place of refuge, travel can both be inspiring, as well as be inspired. Travel facilitates learning more about the world and transforming attitudes and perspectives for the better, both personally and in the lives of loved ones. Travel can be inspiring, as well as be inspired.

Market research indicates that by 2020, the millennial generation will account for half of global travel spending. This particular generation has been seen in the marketing industry to include individuals who are always looking for some level of inside information, wanting something special, and tending to see the process of booking travel as more of a game that involves responding to low prices and interesting packages.

Unfortunately, whether it be for individuals in the millennial generation or any other individual, finding the next perfect destination can be difficult and frustrating. Existing systems, such as Expedia® or Travelzoo®, do not provide a destination search process that is both simple and comprehensive. For example, graphical exploration-style interfaces currently available are not much more than a glorified table of contents for single-category results. Also, travel platforms offering image content are ubiquitous (e.g., Pinterest® and Instagram®) but often fail to link directly to the specific hotel or destination depicted in an image. Other resources, such as Yonder®, Expedia®, Bookings.com, Gogobot®, OnWander®, TripAdvisor®, Google®, are limited in a similar manner, and fail to associate possible experiences with destinations and/or packages. Thus, a user seeking travel experiences from a graphical exploration-style interface, or using a graphical interface like Pinterest®, is often left wondering which destination to choose and how to compare destinations. Companies promote many deals on their websites and use other means as well, e.g., email, but it is still difficult for a user to identify travel destinations and experiences meeting his or her personal travel criteria and preferences, and also difficult to compare multiple potential or suggested travel experiences.

The norm is a destination-first travel search, in which a user identifies a destination and then still needs to piece together travel details and logistics. Details, including lodging, dates, dining, recreation, adventure, sights, etc., can quickly transform trip planning into a time-consuming chore, ultimately resulting in less-than-satisfying decisions. Group travel situations (family, business, friends, clubs, etc.) can quickly compound this already complex situation. In the end, the destination-first approach of travel creates complexity of identifying a travel experience that satisfies a traveler's personal criteria, and that also satisfies other parties that may be involved in the travel, creates a barrier of difficulty that may drive the potential traveler to choose “easy” or familiar destinations rather than something new, inspirational, and unique, and which could have been more desirable and more satisfying. Faced with seemingly insurmountable complexity, the traveler settles for something less than the best option. In other words, the traveler settles for travel experiences that work instead of travel experiences that far exceed the “just work” threshold and are wonderful, new, and inspiring.

### BRIEF SUMMARY

A method and system are disclosed for presenting to a user, and allowing a user to select, a unique travel package tailored to a user's interests and inspirations. A visual exploration interface includes a set of travel experience representations for eliciting travel opinions, preferences, and/or input. For example, the travel experience representations may include visual images that are designed to have emotional responses or inspire travel experiences. Based on a first selection of a travel experience representation, one or more second travel experience representations are identified and presented to the user. One or more travel representations, travel components, and/or travel packages may be ranked or weighted based on the selections of travel experience representations, and one or more travel packages are presented to the user based on the selections and the rankings or weightings. The user may then save for later, select and purchase, make reservations for, and/or request further information on, one or more of the presented travel packages.

In addition to presenting one or more iterations and/or levels of travel experience representations, ranking suggested and/or identified destination, and providing or offering one or more travel packages, the method and system disclosed herein may also obtain user profile information and, using the user profile information, guide presentation of one or more travel experience representations.

A method and system is further disclosed for presenting to a user, and allowing a user to select, a unique purchase package tailored to a user's interests and inspirations. A visual exploration interface includes a set of purchase experience representations for eliciting travel opinions, preferences, and/or input. For example, the purchase experience representations may include visual images that are designed to have emotional responses or inspire purchase experiences. Based on a first selection of a purchase experience representation, one or more second purchase experience representations are identified and presented to the user. One or more purchase representations, purchase components, and/or purchase packages may be ranked or weighted based on the selections of purchase experience representations, and one or more purchase packages are presented to the user based on the selections and the rankings or weightings. The user may then save for later, select and purchase, make reservations for, and/or request further information on, one or more of the presented purchase packages.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1a illustrates a diagram of computer components used to implement features presented herein.

FIG. 1b illustrates a block diagram of modules used to carry out steps described herein.

FIG. 2 illustrates a flow chart showing steps of an exemplary embodiment.

FIG. 3 shows an exemplary VEI on an electronic display of a mobile device.

FIG. 3a shows an exemplary VEI on an electronic display of a mobile device.

FIG. 4 shows an exemplary VEI on an electronic display of a mobile device.

FIG. 5 shows an exemplary VEI on an electronic display of a mobile device.

FIG. 6 shows an exemplary VEI on an electronic display of a mobile device.

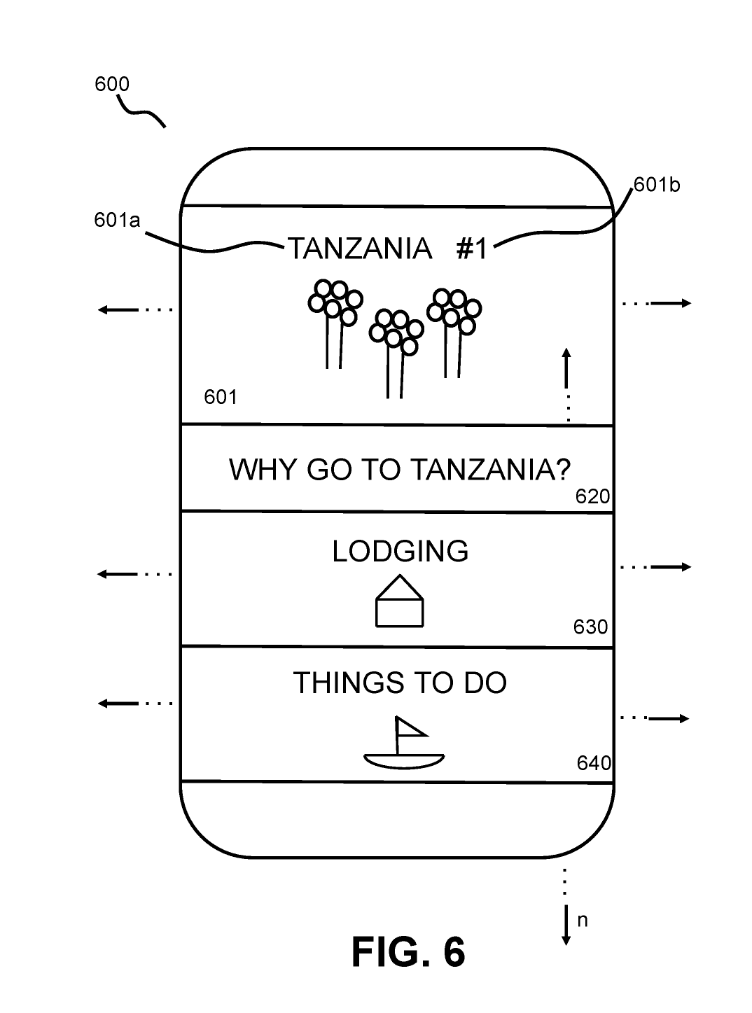

FIG. 7 shows an exemplary VEI on an electronic display of a mobile device.

FIG. 8a shows an exemplary VEI on an electronic display of a mobile device.

FIG. 8b shows an exemplary VEI on an electronic display of a mobile device.

FIG. 9 shows a natural progression of display screens for VEI navigation.

FIG. 10 shows an exemplary VEI on an electronic display of a mobile device.

### DETAILED DESCRIPTION

This application claims priority to U.S. Provisional Application No. 62/240,383 (titled “EPIC TRIP EXPERIENCE APPLICATION”), filed Oct. 12, 2015. The following includes a computer-implemented method and system for presenting to a user, and allowing a user to select, a unique travel package tailored to a user's interests and preferences. Users enter their interests and preferences through a visual exploration process that uses a visual exploration interface to present travel information, such as curated photography, audio, video, 360 video, augmented reality, and/or virtual reality video. A visual exploration interface includes a set of travel experience representations for eliciting user opinions, preferences, and/or input. For example, the travel experience representations may include visual images that are designed to have emotional responses or inspire travel experiences. Based on a first selection of a particular travel experience representation, one or more second travel experience representations are identified and presented to the user. Travel experience representations may be presented to the user iteratively, so that the user selects, in each iteration, one or more of the presented travel experience representations and, based on such selection(s), a further refined subset of travel experience representations are subsequently presented to the user. One or more travel components (e.g., representations, experiences, destinations, etc.) may be ranked based on selected travel experience representations, and one or more travel packages may be presented to the user based on the selections and the rankings. The user may then save for later, select and purchase, make reservations for, and/or request further information on one or more of the presented travel packages.

A computer-implemented method for presenting travel recommendations to a user via a user interface includes presenting at least one first-level travel experience representation; receiving at least one first-level travel experience representation selection from the user; presenting, based on the at least one first-level travel experience representation selection, one or more second-level travel experience representations; receiving, from the user, at least one selection from the second-level travel experience representation; identifying and ranking, based on the user's selection of at least one first-level travel experience representation and at least one second-level travel experience representation, one or more travel recommendations; and presenting one or more travel packages based on the one or more travel recommendations.

The method further comprises receiving a travel package purchase selection from the user. Based on the user selection of the one or more unique travel packages, a particular point of sale may be presented to the user on the interface, and upon authorization by the user, one or more unique travel packages may be procured.

The system and method may be more broadly applied to include other types of purchase experience exploration (e.g. real estate, interior design, fashion, and auto sales) that uses purchase experience representations. A method and system is further disclosed for presenting to a user, and allowing a user to select, a unique purchase package tailored to a user's interests and inspirations. A visual exploration interface includes a set of purchase experience representations for eliciting travel opinions, preferences, and/or input. For example, the purchase experience representations may include visual images that are designed to have emotional responses or inspire purchase experiences. Based on a first selection of a purchase experience representation, one or more second purchase experience representations are identified and presented to the user. One or more purchase representations, purchase components, and/or purchase packages may be ranked or weighted based on the selections of purchase experience representations, and one or more purchase packages are presented to the user based on the selections and the rankings or weightings. The user may then save for later, select and purchase, make reservations for, and/or request further information on, one or more of the presented purchase packages.

To “slide,” as used herein, involves an act or instance of moving one's finger across a touchscreen and/or other displays described herein, to activate a function. For example, sliding the screen from right to left in a photo viewing application may cause navigation to the next photo. While browsing multiple photos, sliding up or down may allow a user to scroll through a photo library (e.g., sliding upward may cause additional photos, photos located “below” the screen in the mind's eye, to become visible as the photo appears to move upward relative to the screen). Also, browsing may appear in a carousel manner, where the last TER is linked to the first TER causing TERs to repeat. Most smartphones allow a user to slide left or right to switch between screens. Multi-touch options allow sliding with multiple fingers to perform different functions.

Although a main reference throughout the description refers to sliding, other navigation methods may be used, such as using arrow keys, hot keys, shortcut keys, voice commands, buttons, display control, or other element known in the art. In addition to sliding, the process of navigating is accomplished by making selections. Selections of TERs and other types of selections as mentioned throughout the specification are accomplished by one or more means of clicking, touching, tapping, right clicking, check box, radio box, using a keyboard to type in a selection, voice command, and any other means commonly known in the art.

Navigating an array of visual representations may include visible images, invisible images, swiping, sliding, changing which images are visible (e.g., multitouch, pinching images/videos/representations with fingers), traversing, unidirectional, mono directional, selecting of an image for presentation of an array of images, tapping on the side of the screen to move one or more images, horizontal display, vertical display, slanted (e.g., array at a 45 degree angle) display, unique categories for a row of images, bottom-to-top slide, top-to-bottom slide, multi-direction slide, and other means known in the art.

Travel Experience Representations

A travel experience representation (“TER”) as used herein is a type of representation that is presented by way of one or more displays in visual, audio, and/or tactile format to a user audience. Types of representations include static images (e.g., photos, drawings, graphical images) and/or dynamic images (e.g., video, computer-generated video, animated video, 360 video, augmented reality, virtual reality video, and/or any image with moving objects), audio recordings, and/or other types of representations, as discussed in further detail below. Note that TERs may be any of, or a combination of, a video, GIF, image, audio clip, icon, computer-generated image, artwork, or any other media representation.

For visual representations, the displays for the visual representations include any kind of display, including electronic display, computer screen, phone screen, touchscreen, projected screen, virtual reality, virtual reality headsets, cardboard, mobile, or other type of display. The user audience may include one or more users, but may include non-human or otherwise automated users.

Content of TERs may be selected that communicates certain colors, types of people, relationships, hue, lighting, texture, scenery, associated memories, sensory experiences, factors that may speak out to a given user, and other features that are meant to inspire or suggest ideas on which a user can build a desired vacation, such as a dream vacation. TERs and/or content of TERs may be set manually by a back-end person or may be set using machine-based learning techniques (e.g., artificial intelligence, big data, analytics). Thus, each TER may be designed to evoke an emotional response from the user.

For visual representations, a type of representation may include an image, a drawing, a GIF, icon, computer-generated image, artwork, photography, curated image, such as curated photography, any other visual representation known in the art, or a combination thereof. Curated photography may include selected images that are noted for inspiring ideas or causing an emotional reaction. Representations may further include audio. For example, audio may be selected to heighten the visual effect of images and video.

Emotions are described in TERs similar to the manner in which emotions are described in films, using imagery and audio. For example, horror films often use dark images, low lighting, and a sequence of images that have a slow or fast timing to provide a high impact that conveys the mood. The sequence of the journey sets up the scene. Similarly, the TERs may be put together in a sequence to set up the scene of an experience.

TERs may further reflect a brand name, for example, TERs may represent the brand's culture and the brand's taste, all described visually by that brand. For example, a set of TERs may represent a Gucci® preferred hotel, a Gucci®-like activity, and/or a Gucci®-quality restaurant. In this manner, TERs reflect a bookable magazine format, presenting ad-like images of brands. Alternatively, TERs may reflect interests and preferences of curated social influencers, celebrities, social media, etc.

While the discussion herein focuses on TERs for travel applications, this type of representation is just one possible purchase representation that could be provided to a user. The system includes a higher level concept of a more generic purchase exploration representation (“PER”), which captures the broader idea of a representation that is used in a visual exploration process to generate one or more purchase options.

Visual Exploration Interface

A visual exploration interface (“VEI”) as used herein includes a user interface that is used to perform and enable the various actions and features described herein, such as exploring a series of travel experience representations and enabling the procurement of at least one unique travel package. The visual exploration process may inspire users to select amazing and unforgettable experiences for themselves and for sharing with friends and families, whether it is simply taking a moment to learn about the natural world around them, pushing physical abilities to the limits with high adventure, or getting pampered at a luxury spa or safari. VEIs may introduce and inspire education, culture, spirituality, self-reflection, appreciation for others, learning about the earth around us, peace, meditation, luxury, sustainability, physical challenge, excitement, adventure, and more.

The disclosed system does this by offering trustworthy recommendations to eliminate guesswork. The disclosed system may further offer emotional-based and experience-based TERs to evoke selections. Users may find the best results for what is new, timeless, or trendiest with information provided. Such information may come from a variety of sources such as travel sites, recreation sites, eco-tourist sites, Google® and other search engines, travel and leisure sites, sites like National Geographic®, social media sites, and hand-selected authentic humanitarian aid organization sites. This list is not intended to be all-inclusive.

The VEI is a fast and easy, yet comprehensive, tool that facilitates interactive travel exploration and selection, and also enables users to find a perfect destination based on the user's selection of visual representations. The interface may be presented on a variety of platforms, including websites, mobile applications, augmented reality, virtual reality, headsets, and other commonly known forums. The VEI may comprise an electronic screen and/or a medium that is not visual at all, such as a medium that uses auditory or tactile senses (see mediums described below).

In one embodiment, a presentation server may present a VEI, including one or more TERs, to a user through a display device. The user may input selections and/or other information through the VEI, and the presentation server may receive these selections and/or input. Through an iterative process, the presentation server may then present further refined sets of TERs. The presented TERs may be refined based on the user's previous selections and/or input. Also based on the user's selections and/or input, the presentation server may rank travel experiences and/or packages, and may present one or more travel packages to the user based on these rankings. The user may then save for later, select and purchase, make reservations for, or request further information on, one or more of the presented travel packages.

The user interface disclosed herein facilitates exploration and selection of travel options, guide toward inspired travel, and provide trusted recommendations to make a satisfying travel experience easy and attainable. Using TERs and/or other types of PERs, applications of the user interface further extend to many industries in eliciting input and desires from users and meeting users' needs, such as real estate, interior design, fashion, and auto sales. Features may include a simple, visual exploration process to select desired experiences, a destination profile for one or more users, image-based search results, elimination of potentially endless research, and top source recommendations based, or not based, on sponsorship, with featured results, all at various price points.

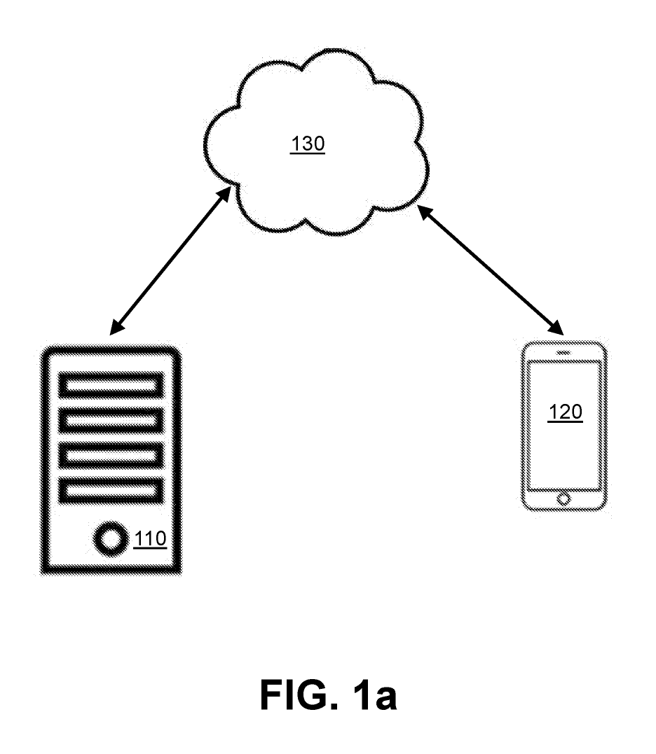

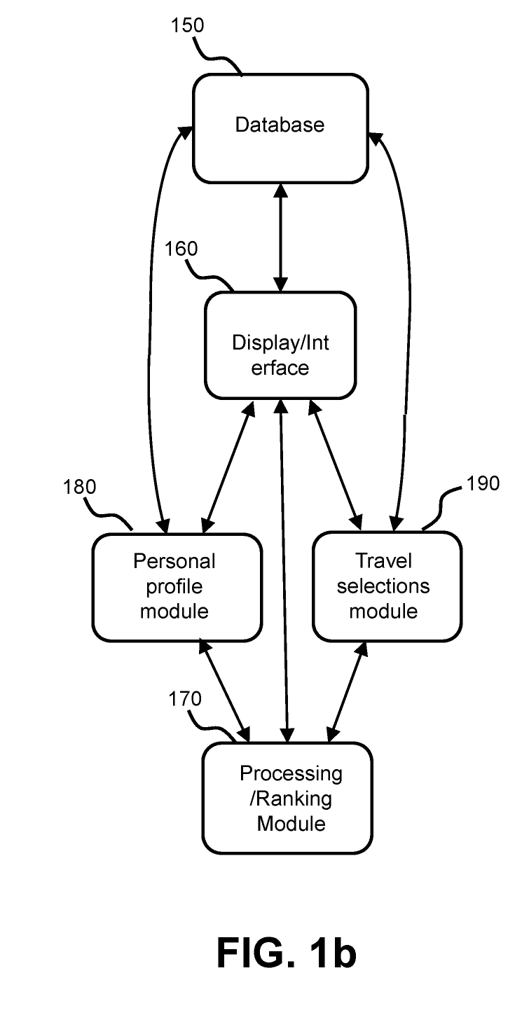

FIG. 1a shows a high-level overview of the components disclosed herein. Presentation server 110 may comprise a computing device designed and/or configured to execute computer instructions, e.g., software, that may be stored on a non-transient computer readable medium. For example, but without limitation, presentation server 110 may comprise a server including at least a processor, volatile memory (e.g., RAM), non-volatile memory (e.g., a hard drive or other non-volatile storage), one or more input and output ports, devices, or interfaces, and buses and/or other communication technologies for these components to communicate with each other and with other devices. Computer instructions may be stored in volatile memory, non-volatile memory, another computer-readable storage medium such as a CD or DVD, on a remote device, or any other computer readable storage medium known in the art. Communication technologies, e.g., buses or otherwise, may be wired, wireless, a combination of such, or any other computer communication technology known in the art. Presentation server 110 may alternatively be implemented on a virtual computing environment, or implemented entirely in hardware, or any combination of such. Presentation server 110 is not limited to implementation on or as a conventional server, but may additionally be implemented, entirely or in part, on a desktop computer, laptop, smart phone, personal display assistant, virtual environment, or other known computing environment or technology.

User display 120 may comprise any computing device capable of displaying a VEI and receiving input from a user. A VEI may be an interface for display on a computer display, smartphone display, or other dynamic visual display. A VEI may be, in whole or in part, or some combination of, a traditional desktop, laptop, smart phone, personal display assistant, holographic display, 3D display, virtual reality display, or any computing device in communication with a display. For representations that include audio formats, devices may include speakers, digital sound makers, and other devices that are known in the art and that produce sounds in an electronically controlled manner. For representations that include tactile formats, devices that output tactile displays may be used. Input devices may include, but are not limited to, a keyboard, mouse, touchscreen, trackpad, holographic display, voice control, tilt control, accelerometer control, or any other computer input technology known in the art.

User display 120 may be in communication with presentation server 110 via any communication technology known in the art, including but not limited to direct wired communications, wired networks, direct wireless communications, wireless networks, local area networks, campus area networks, wide area networks, secured networks, unsecured networks, the Internet, any other computer communication technology known in the art, or any combination of such networks or communication technologies. In a preferred embodiment, user display 120 may communicate with presentation server 110 via network 130, which may be the Internet, network, or the cloud.

FIG. 1b is a block diagram illustrating exemplary modules that are internal to the system and method and which carry out the steps described herein. The modules include database 150, display/interface 160, personal profile module 180, travel selections module 190, and processing/ranking module 170. FIG. 1b will be discussed in conjunction with the other Figures.

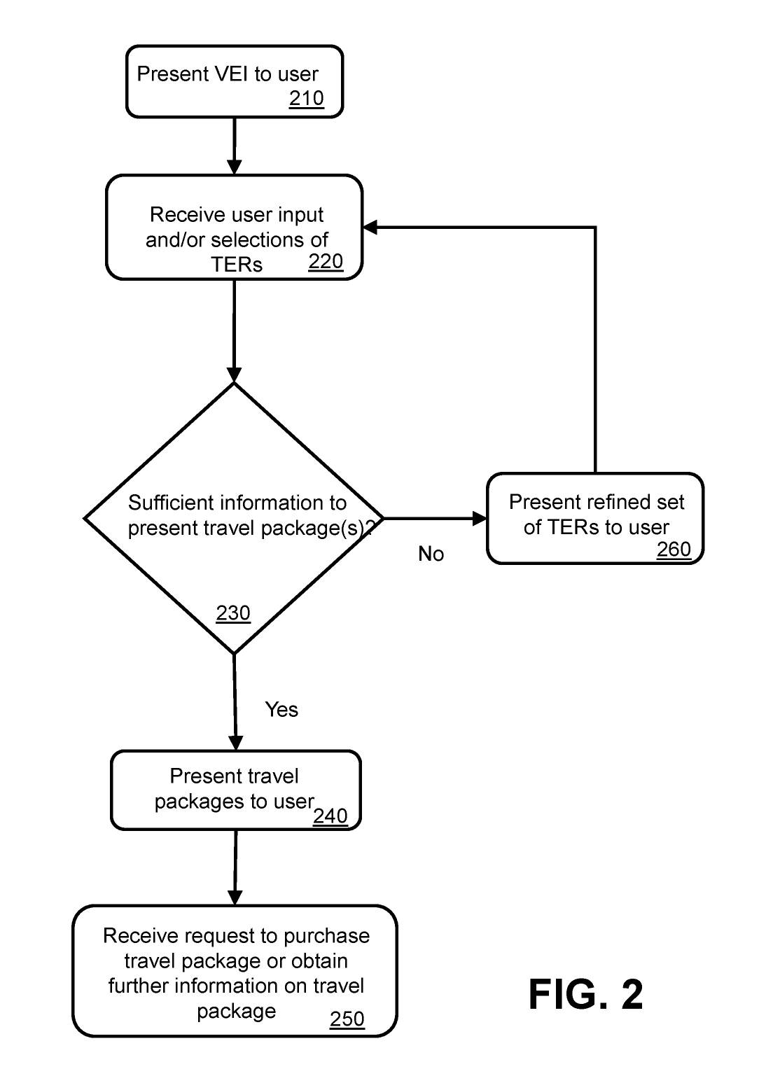

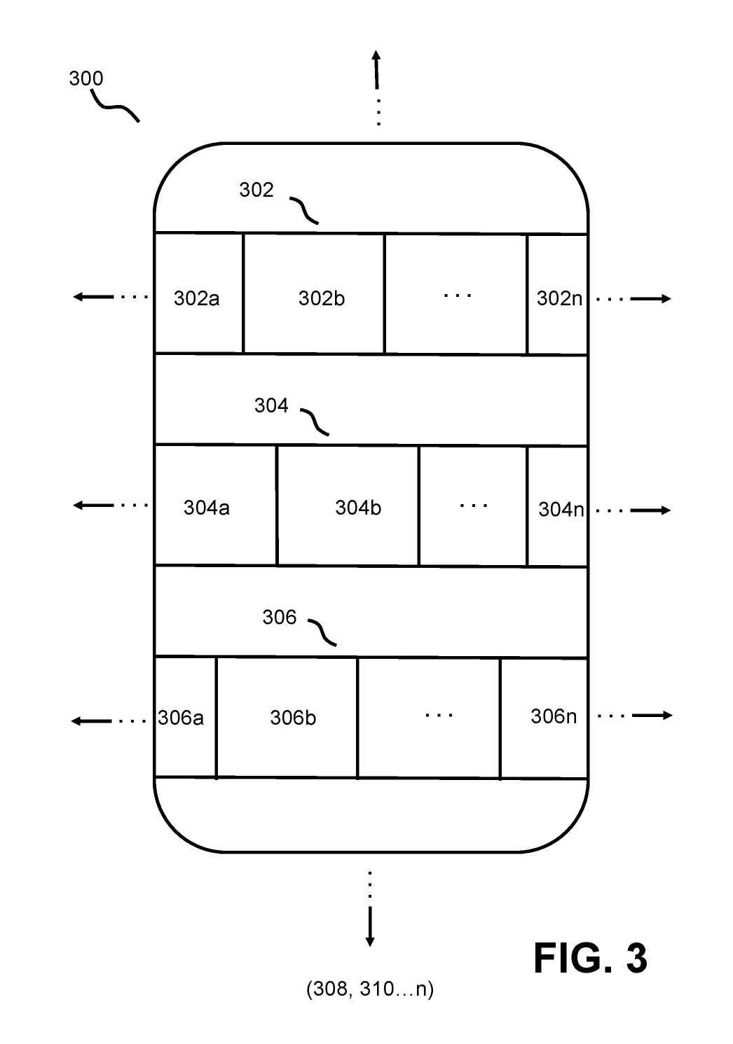

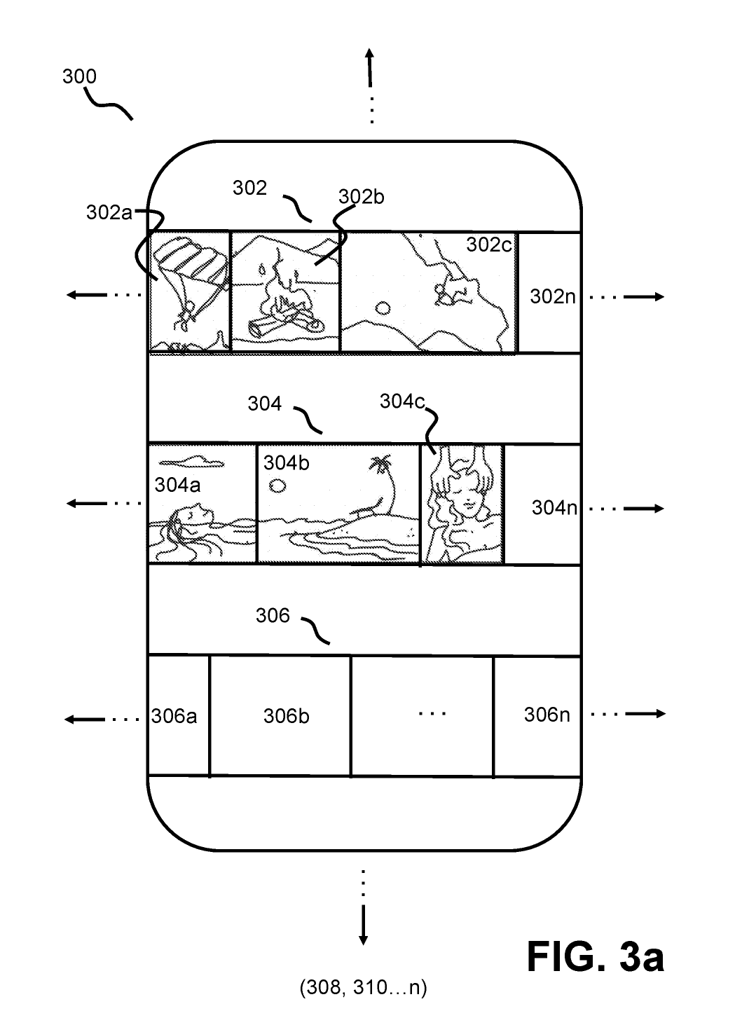

FIG. 2 is a flow chart showing the steps of an exemplary embodiment. At step 210, presentation server 110 may present a VEI to a user on a display 160. FIG. 3 shows an exemplary VEI 300 in the form of an electronic display mobile device (e.g., iPad®, tablet, smartphone, mobile phone), where VEI 300 is configured to facilitate and enable a user to use visual representations (or other types of representations discussed herein) to explore a progressively refined set of travel experiences, and to finally select a travel package or components of a travel package.

To “present,” as used herein, includes but is not limited to, providing a web page or other display or interface for display and use in or through a web browser, or providing data for display in an app or application previously installed on a device, or any other system and/or method known in the art for providing formatted data and controls or interface elements for receiving input.

User Profile

First and second-level TERs may be presented based on a standard or random manner; alternatively, they may be presented to a user according to the user's interests, preferences, or other characteristics. User interests may be gathered by directly or indirectly soliciting or otherwise eliciting information from the user. Such information may be gleaned or scraped from the user's social media accounts and social presences, e.g., Facebook®, from a user's browsing or purchase history, from third parties that sell consumer data, or from any other data gathering or data mining means known in the art. Information on interests, preferences, or other characteristics may include, but are not limited to, adventure, lifestyle, season, desired time-of-year, desired travel dates, climate, geography, event/activity, service opportunities, influencer information, brand preference information, social media subscriptions/accounts, social media usage history, purchasing history, and/or purchasing preferences.

Presentation server 110 may include one or more of a database 150, personal profile module 180, travel selections module 190, and processing/ranking module 170, as shown in FIG. 1b. Presentation server 110 may elicit various preferences through preference selection interfaces. For example, presentation server 110 may present, visually, textually, or otherwise, climate options with details on various options, and receive a user's selection(s) of one or more desirable climates for travel. Presentation server 110 may present a similar interface for any of possible interests, characteristics, or preferences. Selections are taken from the database 150 and made available on the display/interface 160. The user may make selections via display interface 160, and such selections may be stored in travel selections module 190 or personal profile module 180. Static definitions of the user that describe the user's preferences and which are not frequently changed (e.g., height, age, residence) may be stored in personal profile module 180. Dynamic selections, i.e., those which may change frequently (e.g., destination desired, number of people traveling) may be stored in Travel selections module 190.

Presentation system 110 may use user influencer information, which may be stored in personal profile module 180, to determine that a user has a high affinity for a particular celebrity or other notable entity of influence. Presentation system 110 may use this input in its ranking or weighting module 170 to identify travel packages for presentation to the user, or may mark particular TERs or travel packages as being approved of, endorsed by, or recommended by a particular celebrity or influencer entity. Presentation system 110 may also indicate, for some TERs or travel packages, that a celebrity or other influencer entity has traveled to that particular destination or patronized a particular provider of lodging, travel, food, activities, etc.

Personal profile module 180 may further include brand preference information that presentation system 110 may use analogously to the user of influencer information. In short, any information about a user's interests, preferences (e.g. travel, dining, social), or other characteristics may be used by the presentation server 110 to identify, mark, or highlight particular TERs or travel packages, to provide additional information about TERs or travel packages, to determine which TERs or travel packages to present, or to determine how to rank or weight TERs or travel packages.

TERs presented to a user may also depend on the interests, preferences, or other characteristics of a family, a group desiring to travel together, or groups of individuals who may be traveling together for any number of reasons. The same interests, preferences, and characteristics described above for a user may apply similarly to groups of individuals, and may be used as a factor in determining the TERs or travel packages presented to a user. One or both of personal profile module 180 and travel selections module 190 may store and handle this type of information.

Travel Experience Navigations

The TERs presented via VEIs provide a digital canvas for the formation of a tailored travel package. The interfaces presented herein provide easy, intuitive manipulation for accomplishing this task. Example VEIs that will be described in conjunction with the server include interface 300, interface 400, interface 500, interface 600, interface 700, interface 800, interface 801, interface 902, interface 904, interface 906, interface 908; and interface 1000.

In FIG. 3, VEI 300 comprises one or more first-level travel experience representations (TERs). Exemplary first-level TERs are presented in category arrays 302, 304, 306, 308, 310 . . . n. Each array (e.g. 302) presents a linear perspective, or row, of related TERs, (e.g., TER 302a, 302b . . . 302n) for presenting a variety of travel experiences to the user. The ellipses represent that any number of first-level TERs may be included. In the example shown, the user slides left or right to scroll through first-level TERs 302a, 302b . . . 302n, where n is some finite number.

Each level of TERs may be presented in any kind of manner, whether they be in sets, categories, random order, or no order. A set of TERs may be shaped as a square, circle, rectangle, or in any other shape, or combination of shape, or geometry, which may be appropriate or desirable for a particular application. Although shown as a horizontal ribbon for illustrative purposes, first-level TERs 302a, 302b . . . 302n may be organized in other spatial arrangements, e.g., vertical array, circle, two dimensional tiling, or ribbon wherein a centered or focused TER and/or adjacent TERs are larger than the remaining TERs. Many organizations and systems for displaying, reviewing, scrolling through, and otherwise navigating TERs are known in the art and may be employed here.

As described herein above, each array 302, 304, 306 may be associated with a travel experience category. These categories may include, but are not limited to, “Breath of Fresh Air,” “High Adventure,” “Chillax+ Spa,” “Sexy Romantic,” “Serve One Another,” “Eco-Tourism,” “Family Fun,” “Social, Art & Culture,” and any other category that may be applicable to describe a set of related travel experiences. A category may further represent a social influencer, such as a celebrity's preferences of travel, or a brand name's preferences of travel. These category titles may be displayed as part of VEI 300. For example, a category title may be stationary relative to navigation of TERs 302a, 302b . . . 302n and/or may be superimposed over array 302.

In FIG. 3, interface 300 VEI 300 presents an interface for the user to select, among arrays 302, 304, 306, 308, 310, . . . n, one or more of first-level TERs 302a, 302b . . . 302n; 304a, 304b . . . 304n; 306a, 306b . . . 306n; and so forth as indicated by the ellipses on the vertical and horizontal arrows.

FIG. 3a shows a VEI 300 similar to the VEI of FIG. 3, except that TERs 302a, 302b, 302c, 304a, 304b, and 304c are shown with exemplary images that may be associated, e.g., with the category “High Adventure” (302a, 302b, 302c) and “Chillax+ Spa” (304a, 304b, 304c). Images 302a, 302b, and 302c represent images of “High Adventure,” with 302a illustrating a person hang gliding in the sky, 302b illustrating a campfire in the mountains, and 302c illustrating a person rock climbing with a sun in the background. Images 304a, 304b, and 304c represent images of “Chillax+ Spa” with 304a illustrating a woman lying on a beach with a floating cloud in the sky above her, 304b illustrating an island with a single palm tree under a sun, and 304c illustrating a woman with her eyes closed and receiving a massage. Images may evoke ideas, for example, the campfire in the mountains may cause a user to want some type of a cozy experience with a campfire, bonfire, or fireplace. The woman lying on a beach may bring to mind thoughts of warm places with sand and sunshine. The contrast of the fire against a dark backdrop and the bright lighting of the sun as it sparkles on the sand may evoke emotions, stir up memories, and further provide inspiration and ideas to form in a user's mind.

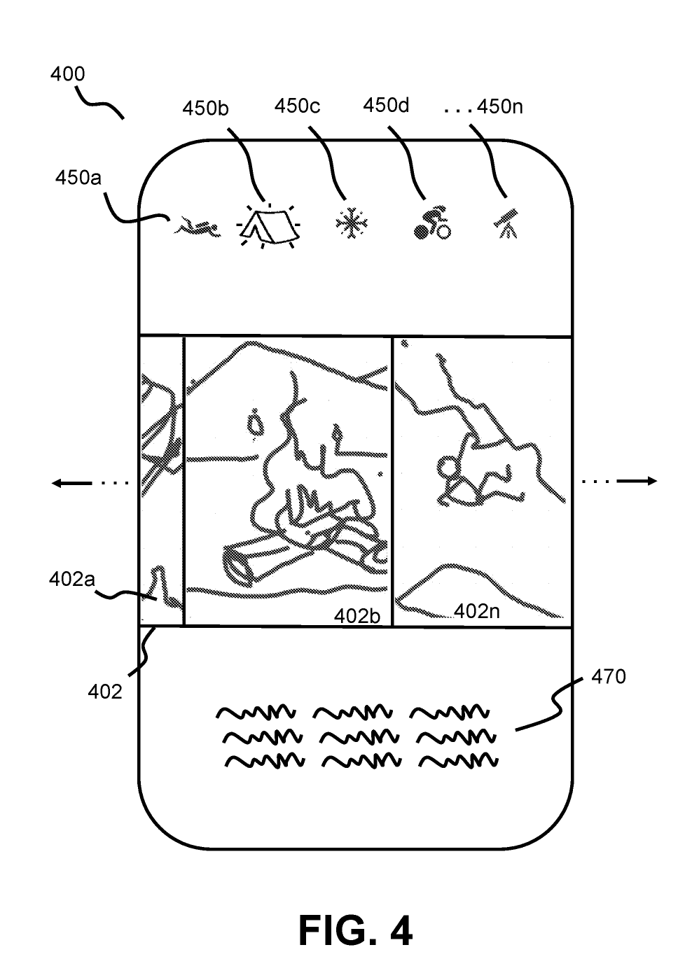

Based on selections of the one or more first-level TERs (e.g. 302a and 302b) that are part of a first-level TER (e.g. 302), this action results in navigation to interface 400 (see FIG. 4), which presents one or more arrays 402 of second-level TERs 402a . . . 402n associated with the selections in the first-level TERs. Additionally, the user may select an entire array (e.g., 302), in which case the entire array (e.g., 302) acts as the first-level TER and also results in navigation to interface 400, which presents one or more arrays 402 of second-level TERs 402a . . . 402n associated with the selected entire array (e.g. 302). Other means of navigation may be used that follows the general pattern of presenting a second set of TERs based on selection of a first set of TERs.

Features may further include showing selected first- and second-level TERs in a larger scale format and in isolation apart from the other first- and second-level TERs. If, for example, the first-level TER presents an array of high adventure images, the array of high adventure images may be enlarged and shown in isolation from the other first-level TERs on a second screen.

In navigating TERs, additional features may include one or more links or triggers for one or more embedded sets of images or videos. For example, a presentation of a dynamic representation may be based on or related to a selected static representation (and vice versa). If, for example, the static representation is a curated image (e.g., sailboat), tapping on the static representation may change the static representation into a video that shows movement and plays music in the background (e.g., someone navigating the sailboat on a beautiful ocean under a sunny sky, and to the sound of music).

Further features may include that the selections may be ranked or rated. For example, a user may rank his or her top three TERs, or may rate one or more TERs on a scale such as a scale of 1-10 with 10 being the most desirable TER and 1 being the least desirable TER.

As shown in FIG. 4, interface 400 may further include icons 450a, 450b, 450c, 450d, . . . 450n, that are associated with one or more second-level TERs 402a . . . 402n. Scuba diver 450a, tent 450b, snow flake 450c, cyclist 450d, . . . telescope 450n shown in interface 400 are exemplary descriptive icons that provide a visual indicator of selections that have been made by the user and that further provide an easy reference or travel log of selections made while navigating through multiple interfaces and sub-interfaces. Other examples of icons, not shown, include a palm tree, and mountain, a volcano, a shark, a whale, a camel, etc.

For example, second-level TERs 402a . . . 402n may initially be greyed out or dimmed to visually indicate that they have not yet been selected, and when selected by a user, a selected second-level TER may brighten, or be colored, or receive a distinctive order, or any other known method of indicating that a second-level TER has been selected. A corresponding icon 450a, 450b, 450c, 450d, . . . 450n may also brighten or otherwise change to indicate selection. If a user selects second-level TER 302c, for example, which may be associated with icon 450b, icon 450b may become highlighted to show that a particular type of experience has been selected. Interface 400 shows that icon 450b has been selected.

Interface 400 may further include descriptor component 470, which may include words, text, or other written information associated with selections made from second-level TERs 402a . . . 402n. Similar to icons 450a, 450b, 450c, 450d, . . . 450n, this written information may provide a textual description to indicate the types of experiences that have been selected. When a user selects a second-level TER, any words in component 470 may appear, be highlighted or otherwise be marked to provide a visual indication to the user that a second-level TER associated with the particular word has been selected.

Returning to FIG. 2, when a user has selected one or more TERs (e.g. first-level), these selections may be transmitted to presentation server 110, and at step 220 received by presentation server 110. At step 230, presentation server 110 determines whether to present suggested travel packages to the user, or whether to possibly present a refined set of TERs (e.g., second-level) to the user. This determination is made by the processing/ranking module 170 (FIG. 1b). If, at step 230, presentation server 110 determines that it has not gathered sufficient information to present travel packages to the user, then at step 260 it may present a refined, or further narrowed, set of TERs to the user.

Presentation server 110 may identify a refined set of TERs in multiple ways. For example, presentation server 110 may use selections of TERs received at step 220 to make refined TERs. Alternatively, presentation server 110 may use both the user input (e.g., user profile) and selections of TERs received at step 220 to refine additional TERs presented to the user. Presentation server 110 may make this determination by reviewing and analyzing the user's interests, preferences, and characteristics, as well as the user selections of one or more TERs received at presentation server 110 at step 220. Once presentation server 110 determines that it has gathered sufficient information, presentation server 110 may determine that it is appropriate to present suggested travel packages to the user, and at step 240 may present suggested travel packages to the user.

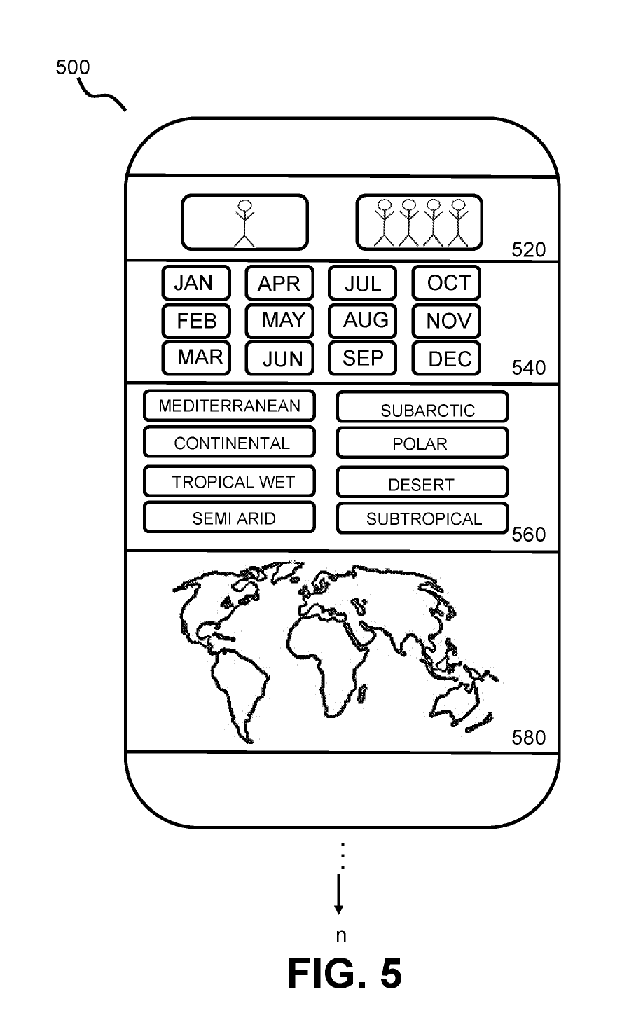

Turning to FIG. 5, interface 500 provides sub-interfaces 520, 540, 560, 580 . . . n to elicit information such as whether the user will be traveling by himself or in a group, the time of year during which the user wishes to travel, the climate preference, desired type of weather, and targeted geographic regions in the world. Interface 500 and sub-interfaces 520, 540, 560, 580, . . . n allow selections for travel that are more generic and not necessarily intended to evoke emotional responses, heighten awareness, or evoke inspiration. For example, in sub-interface 520, the user may select whether he or she is traveling individually or in a group. In sub-interface 540, the user may select one or more months in which he or she will be travelling. In sub-interface 560, the user may select one or more desired or preferred climates. In sub-interface 580, the user may select one or more geographic areas of the world. These preferences may be stored in travel selection module 190 (FIG. 1b). In addition to the user selecting or specifying these preferences, in some embodiments presentation server 110 may suggest selections for these preferences based on the user's selections of TERs, other input from the user, or other information about the user's interests, preferences, or other characteristics.

In one embodiment, presentation server 110 may, based on the user's selection of a geographic region, present additional information about geographic regions, or may present an option to make more granular selection, e.g., by selecting sub-regions of one or more geographic regions.

At interface 600, the user may navigate through multiple suggested travel destinations. The visible travel destination TER 601 shown in the example is for “Tanzania” indicated by 601a and ranking 601b. Navigation to additional suggested destinations is indicated by right and left arrows by TER 601. In this example, the user may slide left and right to view other travel destinations. The travel destinations may be shown in random order, next-highest ranked order (e.g., slide right to move from the #4 ranked travel destination to the #5 ranked travel destination, slide left to move from the #4-ranked travel destination to the #3-ranked travel destination), or other order as provided or as tailored by the user.

Below each destination, a variety of travel components may be provided, as indicated by TERs 620, 630, 640, . . . n, with navigation indicated by vertical arrows. The TERs 620, 630, 640, . . . n may be associated with a variety of travel components, such as information of interest (e.g., 620 “WHY GO TO TANZANIA?”), places for lodging (e.g., 630 “LODGING”), and activities therein (e.g., 640 “THINGS TO DO). Similar components may be navigated as indicated by horizontal arrows. Note that instead of dividing each screen by destination, each screen may be divided by one of the components shown below (e.g., information of interest, places for lodging, activities, or other component). In such cases, the destination would become a component shown below the main category.

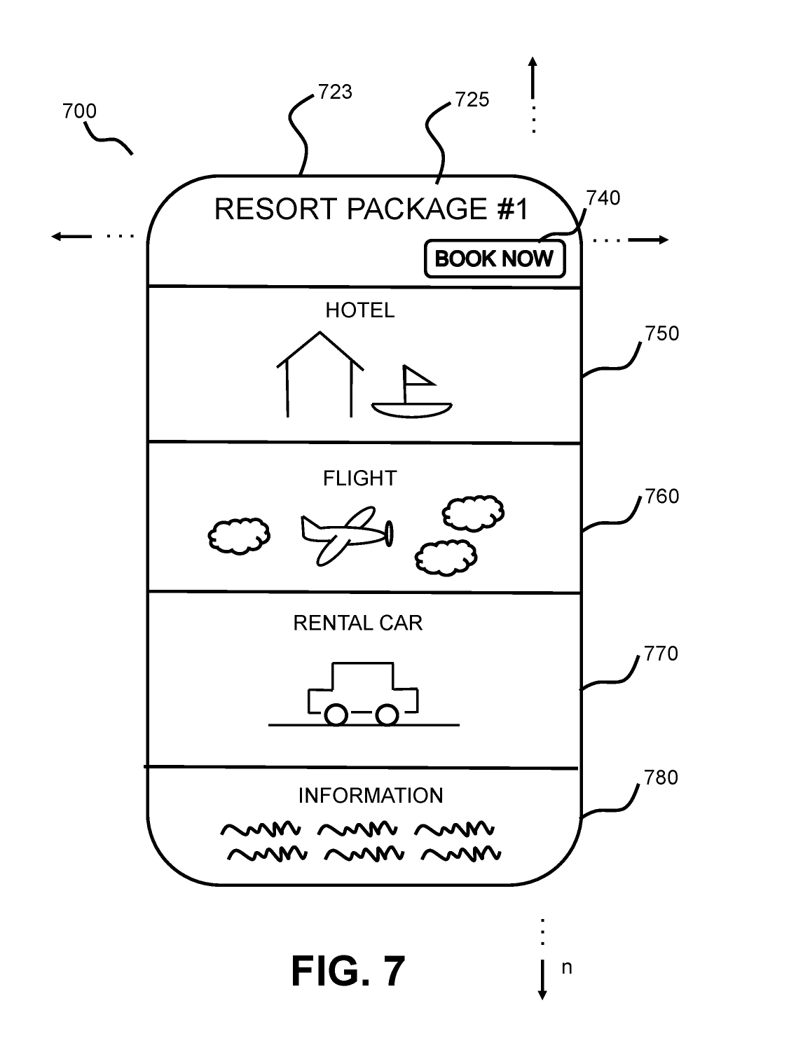

At step 240, presentation server 110 presents one or more suggested travel packages to the user with interface 700, as shown in FIG. 7. A travel package is a package that includes one or more user selections (e.g., TERs, user profile information) and/or is based on previous selections (e.g., TERs, user profile information) to provide the best travel experience for the user. A travel package 725 may include one component (e.g., destination) or may include multiple components (e.g., destination+hotel+car).

Interface 700 may show one travel package at a time, each travel package made visible by sliding between screens as indicated by horizontal arrows, or otherwise navigating through travel package options as known in the art. As shown, sub-interface 723 presents the component(s) 750, 760, 770, 780, . . . n of travel package 725 all together, including hotel 750, flight 760, and rental car 770, . . . n. Additional information about the travel package 725 may further be provided, as shown by information box 780. There is also an option to directly purchase the travel package 725, as shown by a “Book Now” option 740. For any presentation of a suggested travel package or component of a suggested travel package, presentation server 110 may show an option allowing the user to purchase the presented travel package or component on the spot, or to request further information, or to request assistance with booking.

A set of various travel packages may be navigated, as shown by horizontal arrows with ellipses. The various travel packages may be navigated in an orderly manner, such as by highest to lowest ranking, nearest to farthest location, price, or other orders as set by the user preferences. The highest ranked package 725 is shown in FIG. 7, and is indicated in the title by the #1. Other means may be used if an indication or ranking or order is desired. Note that the number of travel package components may be tailored to the user's specification; alternatively, the travel package 725 may provide an automated number of components.

Additional information for a presented travel package may be revealed or otherwise presented by tapping or otherwise selecting the particular travel component 750, 760, 770, . . . n. This additional information may include, but is not limited to, images, videos, pricing information, other information, or the ability to request additional information about the lodging option.

Travel packages may further include custom-ranked, top source-recommended destinations, lodging, restaurants, and activities, all at varying or preselected price points. Examples include treehouse lodges, underwater hotels, dining in the sky, high adventure experiences, Airbnb®, and much more. A database may be amassed from a variety of sources, such as top-tier travel sources, recognized recreation sources, and travel guide sources. Top-featured destinations may further be presented because they have a similar ranking relative to the one or more travel packages presented to the user. For example, the top-featured destinations may be associated with the same TERs selected by the user, and so they are presented to the user in conjunction with the one or more travel packages.

Presented travel packages may be visually marked to indicate pricing levels, e.g., using a different number of “$” signs to indicate pricing (e.g., “$$$$$” for very expensive, “$” for very inexpensive), or using a color spectrum or continuum to indicate pricing level, or by any technique known in the art to visually communicate a pricing level of a particular product or service, especially as compared with another product or service. In one embodiment, suggested travel packages may be marked with colors such as yellow, orange, red, and aqua indicating high, mid, low, and free price levels, respectively.

In addition to selecting and/or presenting TERs and/or travel packages from its own database, presentation server 110 may search other resources, e.g., the Internet. In some embodiments, presentation server 110 may also have a knowledgeable or expert human manually identify TERs or suggested travel packages for presentation to a user.

Presentation server 110 may indicate a status of a particular travel service provider, including, e.g., whether a particular travel service provider is a paying partner, a sponsor, or has some other status or treatment which may affect a user's decision as to whether to select such provider.

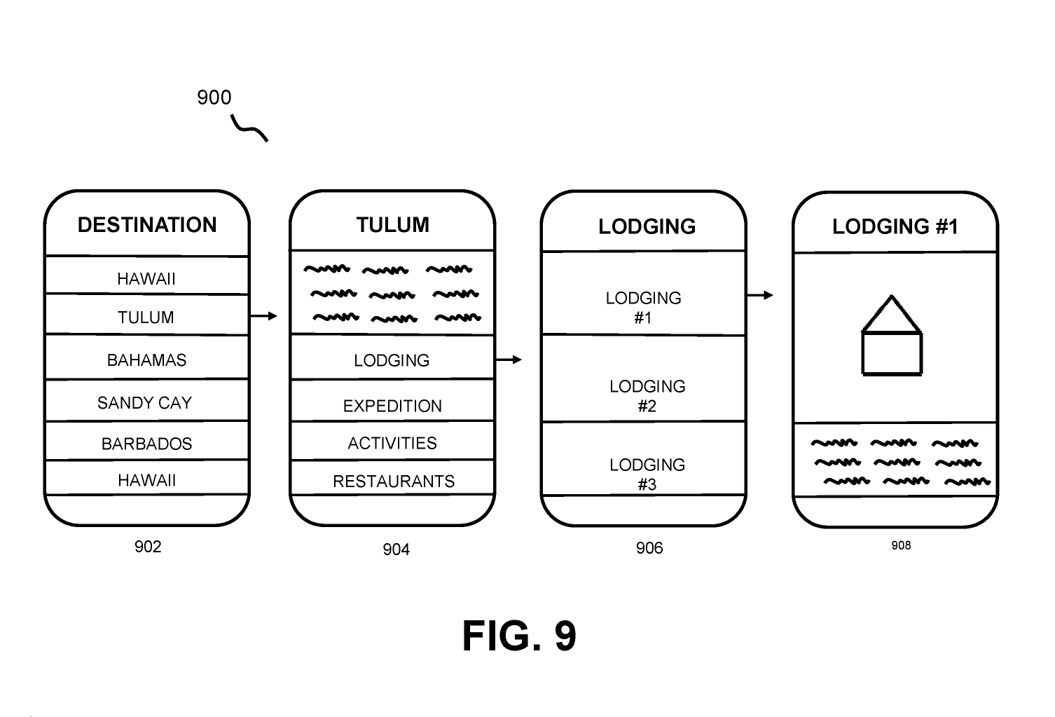

An exemplary navigation process is shown in FIG. 9, with sub-interfaces 902, 904, 906, and 908. The first sub-interface 902 begins with a list of destinations. A selection is made, and based on the destination selected, the second sub-interface 904 presents components, such as information, lodging, expedition, activities, and restaurants. Based on a selection for lodging preferences, the third sub-interface 906 presents lodging options. As depicted in FIG. 9, lodging #1, lodging #2, and lodging #3 are shown. Based on a selection of lodging #1, this lodging choice is expanded in sub-interface 908 to reveal further information, details and booking options. Thus, this progression, as well as other progressions described herein, are meant to be natural and invite the scope of imagination.

Ranking

As stated previously, the TERs and/or travel packages presented to a user may reflect a ranking. For example, based on the user's input and TER selections, presentation server 110 may rank TERs, components (e.g., destinations, activities, lodging, hotel, dining, etc.), and/or travel packages, and may present TERs, components, and/or travel packages to the user in a manner that visually informs the user of the ranking. In determining a destination package, components and/or TERs (e.g., images, videos) may be ranked when they are selected. Accordingly, a destination (or other component) or travel package with the highest number of selected images may be the destination (or other component) or travel package that is presented to the user. In addition, rankings of TERs, components, and/or travel packages may also be based on interests, preferences, and/or characteristics of the user or group, such as desired adventures, lifestyles, season, events, and service opportunities. Thus, the VEI provides customized and inspiring travel recommendations based on the user's wants and needs. Suggested results may include highly rated destinations/hotels, spas and restaurants, and corresponding activities all at varying price points. The travel recommendations may include top-ranked curated experiences for the user or group.

Travel destinations may be weighted instead of or in addition to being ranked. For example, travel packages may be weighted by a number from 1-10 (e.g., 10 being the best match and 1 being the worst match), or by color, or by the size of icon displayed to the user, or in any other manner known in the art for displaying relative values or match strength or suggestion strength of a particular option. These weightings may be presented to the user through the interfaces disclosed herein.

Presentation server 110 may weight or rank destinations based on particular destination features. For example, presentation server 110 may maintain a ranking/weighting of kiteboarding. In some embodiments, when a user selects a TER associated with kiteboarding, presentation server 110 may weight or rank the TERs or travel packages subsequently presented to the user based, at least in part, on its internal ranking/weighting of TERs, travel packages, and/or destinations that are good for kiteboarding. Rankings/weightings of TERs, travel packages, and/or destinations for particular features may be generated by a team that personally applies rankings or weightings; a top 10 destination list; tags for TERs, travel packages, destinations or other components; or in one of many other techniques for ranking and weighting known in the art.

At either of steps 260 or 240, presentation server 110 may additionally present to the user an indication of the reason(s) for presenting particular TERs, components, or travel packages. The user may tap, or otherwise select in any way known in the art, one or more of the presented indications. Presentation server 110 may use this information in its subsequent selection(s) of TERs and/or travel packages for the user.

For example, if five out of ten selected TERs are associated with the High Adventure category, then presentation server 110 may present an interface indicating that presented TERs, travel package, and/or destinations were selected for presentation, at least in part, based on the categories associated with the user's selected TER selections. For example, the interface may display, “Why Trepic's system came up with this destination [or option, or travel package] for you,” and may indicate that the user's previous selections were, e.g.:

50% High Adventure

20% Sexy Romantic

30% Social, Art & Culture

Social Aspect

Additional resources may also be included to provide a gathering of ideas or to generate enthusiasm and interest for travel destinations. For example, social media profiles may be provided so that users may communicate with other users. Travel blogs may be provided to further share experiences, ideas, trip highlights, etc. Photography and/or video may be displayed on social media profiles or other sites. Users may comment on and/or like photos. Photo and/or video contests may be held to garner interest and attention of destination sites and experiences, with feature pages for winning photographers. Photography and/or video may also be added to the images to be selected for determining one or more travel packages. Feature pages may be provided for winning photos and/or videos. Communication may be enhanced with VEIs that include translations and the capability of using different languages.

An Instagram®-like account may exist where users can upload photos, videos, and other information. Liking and following, as well as additional features discussed herein, may also be present, such as the ability to create a trip, create an itinerary, obtain lodging, and schedule activities. Users can adapt trips from other trips that are shared or otherwise available. Users can adopt the same trips that are shared. Also, users can share their trips with others.

Social Media sharing may be available (e.g., from any page in the app/site they can share any destination on Facebook® or Twitter® for example, “Check this out, Trepic found my next epic trip!”). There may also be social media sharing for Groups. For example, a user can invite others to participate in the VEP to generate unified destination results.

A user profile page may be provided with the VEP, complete with a passport mapping, current location, and social media information. A passport mapping may provide information such as travel history, previous or upcoming travel packages procured, future destinations, passport information, and other travel information. The user profile page may further provide a user with a status as a Travel Pro or Elite Photographer based on the number of followers or “likes” on their submitted photos and/or videos.

Group Travel

As stated previously (see control 520 in FIG. 5), the search for travel packages described herein may be group-centric instead of individual-centric. This is beneficial where, for example, a group is planning to travel together, e.g., as friends, family, a professional group, or a sports team, or for any situation that may be amenable to group travel. In this embodiment, presentation server 110 may use the interests, preferences, and characteristics of some or all members of a group, or may use group characteristics such as group size, age of youngest or oldest person, characteristics of any group member that may preclude a particular destination or activity, or any other characteristic of a group. For group travel, selected TERs may be ranked or weighted collectively, where all of the individual selections and rankings are taken into account to derive TERs, travel components, and/or the one or more travel packages.

In one embodiment, an interface such as a dialog box may be presented upon a user's selection of the “Group” button. The interface may ask, “Would you like to create a new group or search for your group?” If the user creates a new group, then the interface may present an opportunity to “Share with your friends on Facebook®” The user may select one or more of his or her Facebook® friends for an invitation to become a user and join the VEP group. Other social media sources may also be utilized to facilitate a group-centric interface.

In one embodiment, a user may sign into a group account. When a user is signed into a group account, or when the system is otherwise configured for group mode, the disclosed system may provide an identification of group members, a history of search results by each group member, an aggregated history of search results over all members of the group, the ability to mix and match potential group members to determine what group search results may occur from different sets of group members, the ability to appoint a group leader to guide a group in its searches and selections, the ability to integrate particular individual searches in group search results, and/or the ability to merge search results from one or more groups.

Purchase Travel Experience

Presentation system 110 may present lodging advertisements, activities, and paying partners. Upon a user's selection of a lodging or activity advertisement, presentation server 110 may offer a discount, e.g., “To reserve this experience, please contact us at reservations@trepic.co and mention code: &BTANZANIA”

The presentation server 110, or an associated application, may provide booking functionality, such as providing a VEI that allows a user to choose dates and formalize reservations/booking for lodging stay or experience. The VEI may further allow a user to “check in” and “check out” of a lodging reservation upon arrival and departure, respectively.

Bucket List

In one embodiment, a user may plan, or dream as it were, about future travel by generating a list of potential adventures, destinations, options, and/or packages, which may be referred to as a “bucket list.” For example, a user may select a star icon associated with a TER, travel package, or destination, causing storage of the selected TER, travel package, or destination as an element of a bucket list.

The user may select a bucket list destination to navigate to an interactive map showing other destinations near or in the vicinity of the of the selected bucket list destination. Using the interactive map interface, or any other interface known in the art, the user may add destinations to create a multi-destination itinerary. For example, a user may have Greece on his or her bucket list. France and Italy may have top lodging and experiences near Greece. The user MAY add the top lodging and experiences to his or her itinerary and edit his or her itinerary. A “Book Now” button may also be provided in association with a user's bucket list selection.

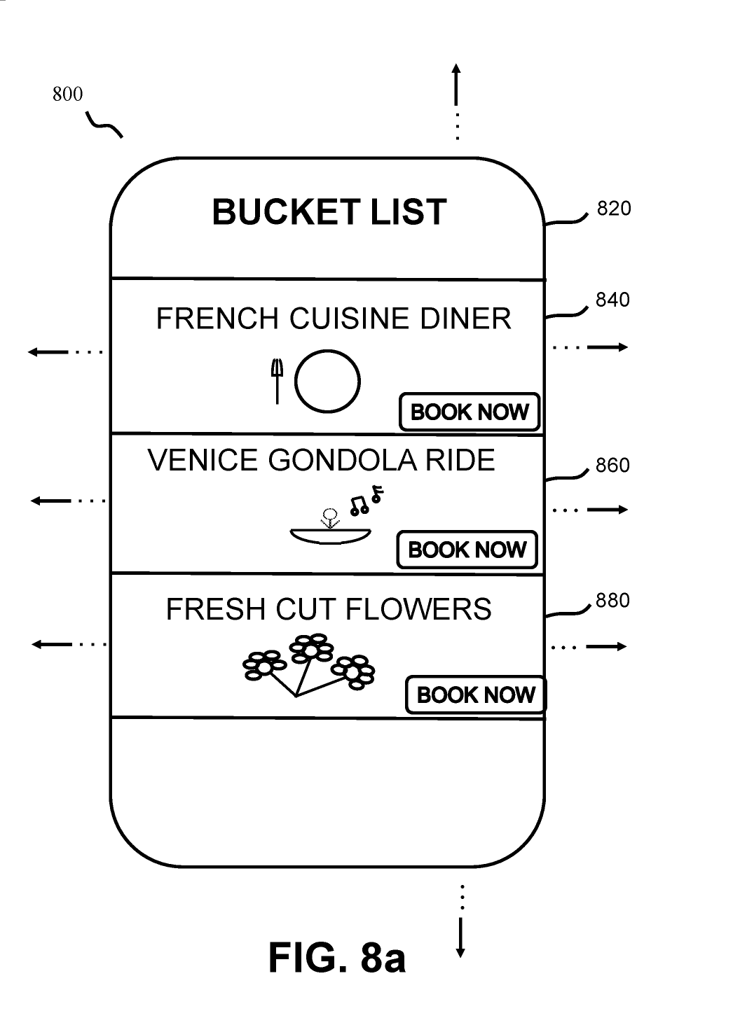

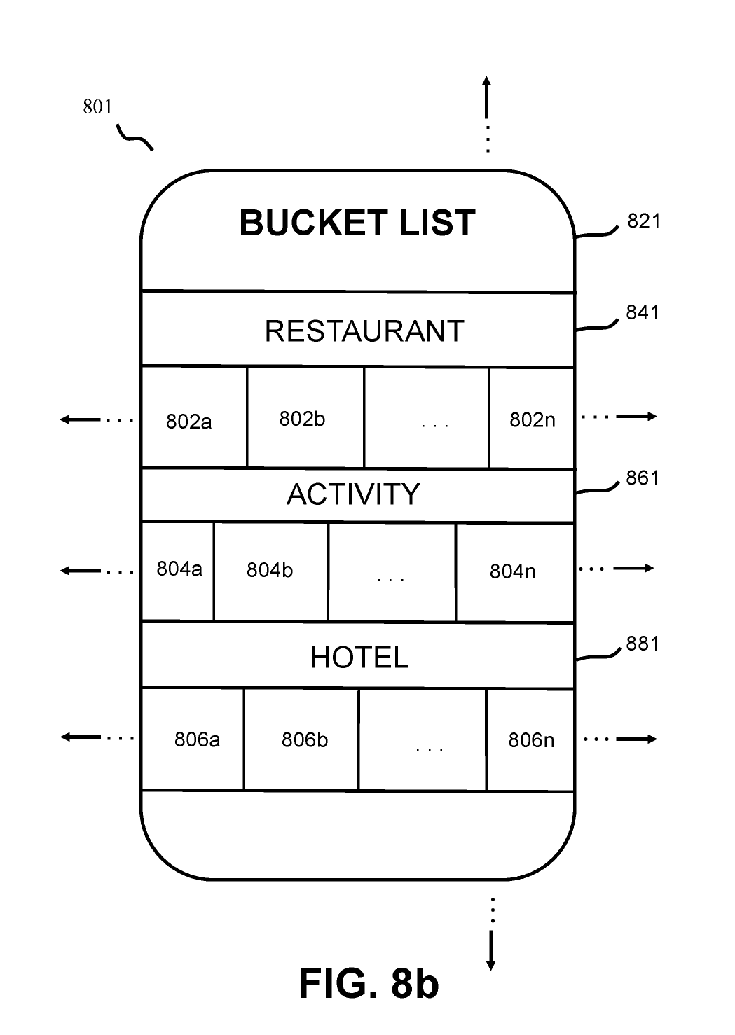

As shown in FIG. 8a, interactive display 800 presents to the user an interface 820 for creating a personalized travel package, which may be comprised of travel package components 840, 860, 880, etc. The ellipses on the top, bottom, and sides indicate that a user may slide up and down, and side to side, to view multiple options. Itineraries with dining, activities, excursions, amenities, lodging, and other options may thus be stored and mixed and matched as desired for both present and future booking.

As shown in FIG. 8b another interactive display 801 presents to the user an interface 821 for navigating first-level TERs 802a, 802b, . . . 802n; 804a, 804b, . . . 804n; 806a, 806b, 806n; etc., which would then be followed by navigation through associated second-level TERs similar to previous interfaces described. The selections may be saved for later as desired.

Along with the bucket list, presentation server 110, or an associated application, may present an interface for the user to view destinations on a map and/or visually build multi-destination itineraries for his or her bucket list.

Traveling groups may also use the bucket list functionality. For example, one or more group members may generate and maintain their own respective bucket lists. The presentation server 110, or an associated application, may present an interactive group bucket list through which all groups users may view and edit bucket list destinations and itineraries for the group.

Users may also share planned and completed itineraries. In one embodiment, presentation server 110, or an associated application, may present an interface for users to search by the most popular TERs, travel packages, travel package components, or itineraries. Presentation server 110 may also identify, e.g., by adding an icon or other identifier, TERs, components (e.g. destination), travel packages, or itineraries that are popular, or may indicate the frequency with which such are selected by other users. The disclosed system and method may also provide opportunities for the travel and photography/videography community to interact, be inspired, and grow with awards and prizes for sharing community and artistic excellence.

Note that a user or group registration and login may provide security. The user's or group's VEP preference, contact information, VEP preferences, bucket list, saved itineraries, and profile information may be saved.

Additional Features

The following additional features may also be included to enhance the user experience.

Alternatively, or in addition to selecting one or more of TERs, the user may use keyword searches to drive presentation server 110′s selection of TERs for presentation to the user. A keyword search is, in essence, another type of input that the user may provide to presentation server 110 for use as one of the bases or inputs for determining which TERs, travel packages, or destinations to present to a user.

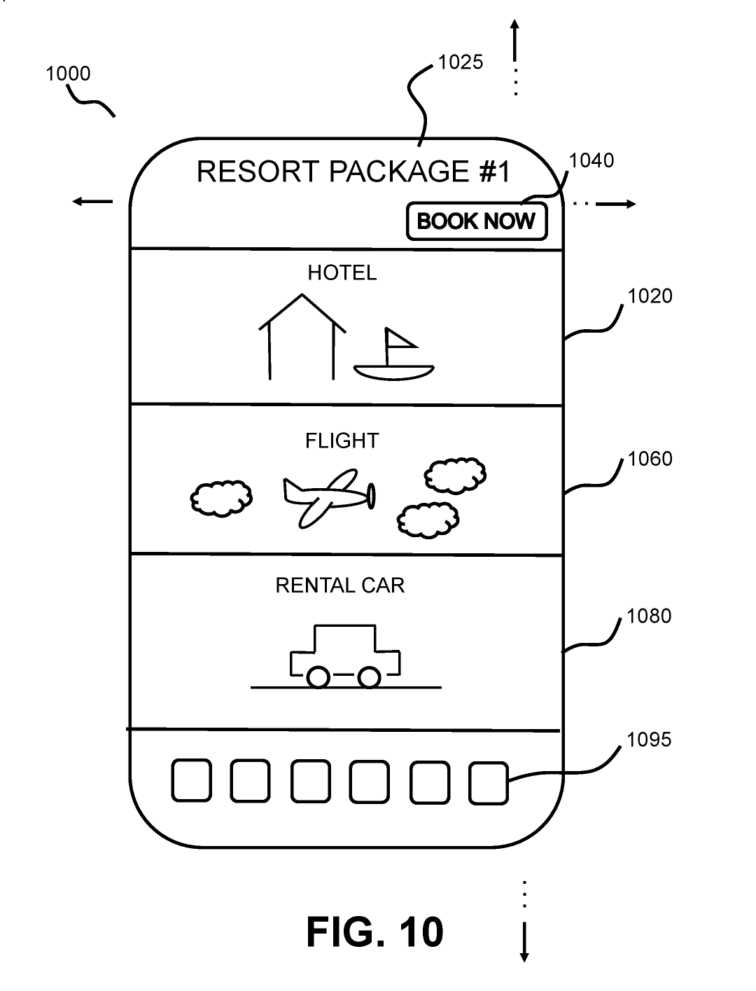

Presentation server 110 may monitor or track a user's navigation, e.g., linger time on a particular TER, or selection frequency for a particular class of TERs, and may use this data as an input to guide, at least in part, the user's search. Furthermore, a user may also track navigation and selections. For example, as shown in FIG. 10, navigation interface 1000 that presents travel package 1025 has a “Book Now” option 1040, and components 1020, 1060, and 1080; in addition, a series of previous selections made by the user that have been used to present this travel package 1025 are represented as detail icons 1095 at the bottom of the screen. Although shown with reference to a particular sub-interface, the detail icons may appear throughout one or more interfaces and sub-interfaces to help guide the user. Although shown at the bottom of the screen, any type of display may be used to indicate the information to the user.

For shopping, presentation server 110 may provide tags on items or services in any image, video, or other visual representation, such that the tag provides an opportunity to purchase, or to get more information on possibly purchasing, an item shown in a visual representation. The tags may be visible tags (e.g., labels, dots, other visible indicators), invisible tags, or tags that appear when hovering over an image or item. For example, in an image showing people swimming, one or more bathing suits may be tagged, e.g., with a distinctive icon indicating that information is available on purchasing an item. In one embodiment, a user may select the tag icon, which may result in a dialog box, or navigation to another interface for purchase of an item. Additionally, users may opt to directly search a database of tagged products or services. Results may be presented visually, using photographs matched by keywords and tags.

The disclosed system and method may further present a recommendations list (similar to Amazon.com®) with recommended/partner destinations, lodging, and activities based on user's likes, VEP selections, and previous trips. Some curated TERS, travel packages, or travel package components may not have a contract/partner relationship with the disclosed system. For such components, presentation server 110 may prompt a user to vote for contract/partner status (e.g., by selecting a control marked “EPIC!” and/or “Vote for this to be available to book and we'll place it at the top of the list!”). Presentation server 110 may track the number of votes for a particular TER, travel package, or travel package component. Presentation server 110 may offer both contract/partner and non-contract/partner TERs, travel packages, or travel package components.

There may be advertisements (e.g., banner ads) with partnered brands via the VEP (Visual Exploration Process). Curated ads specifically expressing an experience—usually an adventure shot or mood or experience that may also showcase a product involved (such as a tent for a backpacking adventure photo for a brand like Patagonia®, or a snowboard shot of a guy flying off a cliff)—may be provided, along with the ability for the user to add the experience or product to their shopping cart to further their purchase of an entire travel package or experience.

In one embodiment, presentation server 110, or an associated application, may present an interface with map tools to facilitate geographic identification of top-curated travel packages, travel package components, or destinations. In one embodiment, presentation server 110, or an associated application, may dynamically present updated travel prices as travel dates or originations/destinations, or destination ordering, are modified through a map interface.

Features may further include maps with the ability to view and select pictures of destinations, pins of curated places to stay and play, top-featured destinations, locations of photography/videography from contests, total approximate trip costs, travel costs to destinations based on the user's location (e.g., flight costs, vehicle costs, public transportation costs), and an aggregation of on-going deals related to desired destinations. Maps may be used to present TERs that have been selected or liked by the user; maps may further be used to present TERs that have been procured by the user in the past. Maps may be presented on a 2D or a 3D visual, for example, a 3D representation of a globe that may be spun around by the user. Using maps, a travel package may be booked by navigating through the TERs and other features presented on the map.

A map interface may also provide visual markers to identify approved and/or curated travel package components or service providers. This may help a user already at a location to easily find other approved and/or curated travel package components such as lodging, activities, and nearby destinations.

Presentation server 110, or an associated application, may present an animated “wizard” bubble or tooltip, which may appear on the visual interface for a limited amount of time, i.e., five seconds. The user may double tap, for example, to launch a help interface.

Conclusion

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other non-transitory computer-readable media for carrying or storing computer-executable instructions and/or data structures. Such computer-readable media may be any available media that can be accessed by a general-purpose or special-purpose computer system. Computer-readable media that store computer-executable instructions and/or data are computer storage media. Computer-readable media that carry computer-executable instructions and/or data are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media may include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media may be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, byte code, interpreted code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A computer-implemented method for presenting a purchase package, comprising:
presenting at least one first-level purchase experience representation;
receiving a selection of at least one first-level purchase experience representation;
presenting, based on the selection of at least one first-level purchase experience representation, at least one second-level purchase experience representation;
receiving at least one selection of the at least one second-level purchase experience representation;
identifying and ranking, based on the selection of at least one first-level purchase experience representation and the selection of the at least one second-level purchase experience representation, at least one purchase recommendation; and
presenting at least one purchase package that corresponds to the at least one purchase recommendation.

2. The method of claim 1, further comprising:
obtaining user profile information, and
using the user profile information for at least one of 1) presenting a first-level purchase experience representation, 2) presenting a second-level purchase experience representation, 3) ranking a purchase recommendation, and 4) presenting a purchase package.

3. The method of claim 2, wherein the user profile information includes at least one of:
influencer information;
brand preference information;
purchase preferences;
interests;
characteristics;
social media usage history;
purchasing history; and
social media subscription information.

4. The method of claim 1, further comprising receiving a purchase of a purchase package from the user.

5. The method of claim 1, wherein presenting a purchase experience representation comprises:
presenting, on a display, an interface having a navigable array of visual images, the interface configured for at least one of:
vertical, horizontal, or slanted sliding to traverse the navigable array of visual images;
vertical, horizontal, or slanted sliding to display at least one previously invisible image from the navigable array of visual images;
selecting an image from the navigable array of visual images to display additional visual images; and
tapping a side of the display to traverse the navigable array of visual images.

6. The method of claim 1, wherein presenting, based on the selection of at least one purchase experience representation, at least one second-level purchase experience representation, comprises presenting an array of visual purchase experience representations based on the selection of at least one first-level purchase experience representation.

7. The method of claim 1, further comprising:
presenting at least one first visual representation of at least one descriptor of geographic features including one or more of time of year, region, continent, country, weather, and climate; and
based on user selection of at least one of the at least one first visual representation, presenting a second visual representation of at least one descriptor of geographic features.

8. The method of claim 1, wherein a purchase experience representation includes one or more of a static image, animated image, moving image, video, 360-degree video, icon image, artistic image, holographic image, projected image, 3-dimensional image, tangible image, computer-generated image, augmented reality, virtual reality, artistic video, computer-generated video, animated video, gif, and audio recording.

9. The method of claim 1, wherein at least one purchase experience representation includes at least one tagged item having a tag, and wherein selecting the tag for the at least one tagged item enables purchase of the tagged item.

10. The method of claim 1, wherein identifying and ranking further comprises identifying and ranking at least one purchase recommendation based on selections of purchase experience representations by two or more users.

11. A computer program product comprising one or more computer-readable storage media having thereon computer-executable instructions that are structured such that, when interpreted by one or more processors associated with a computing system, cause the computing system to perform a method for presenting travel recommendations to a user on a user interface, the method comprising:
presenting at least one first-level travel experience representation;
receiving a selection of at least one first-level travel experience representation;
presenting, based on the selection of at least one first-level travel experience representation, at least one second-level travel experience representation;
receiving at least one selection of the at least one second-level travel experience representation;
identifying and ranking, based on the selection of at least one first-level travel experience representation and the selection of the at least one second-level travel experience representation, at least one travel recommendation; and
presenting at least one travel package that corresponds to the at least one travel recommendation.

12. The computer program product of claim 11, further comprising:
obtaining user profile information, and
using the user profile information for at least one of 1) presenting a first-level travel experience representation, 2) presenting a second-level travel experience representation, 3) ranking a travel recommendation, and 4) presenting a travel package.

13. The computer program product of claim 12, wherein the user profile information includes one or more of:
influencer information;
brand preference information;
travel preferences;
interests;
characteristics;
social media usage history;
purchasing history;
purchasing preference; and
social media subscription information.

14. The computer program product of claim 11, further comprising receiving a purchase of a travel package from the user.

15. The computer program product of claim 11, wherein presenting a travel experience representation comprises:
presenting, on a display, an interface having a navigable array of visual images, the interface configured for at least one of:
vertical, horizontal, or slanted sliding to traverse the navigable array of visual images;
vertical, horizontal, or slanted sliding to display at least one previously invisible image from the navigable array of visual images;
selecting an image from the navigable array of visual images to display additional visual images; and
tapping a side of the display to traverse the navigable array of visual images.

16. The computer program product of claim 1, wherein presenting, based on the selection of at least one travel experience representation, at least one second-level travel experience representation, comprises presenting an array of visual travel experience representations based on the selection of at least one first-level travel experience representation.

17. The computer program product of claim 1, further comprising:
presenting at least one first visual representation of at least one descriptor of geographic features including one or more of time of year, region, continent, country, weather, and climate; and
based on user selection of the at least one first visual representation, presenting a second visual representation of at least one descriptor of geographic features.

18. The computer program product of claim 1, wherein a travel experience representation includes one or more of a static image, animated image, moving image, video, 360-degree video, icon image, artistic image, holographic image, projected image, 3 dimensional image, tangible image, computer-generated image, augmented reality, virtual reality, artistic video, computer-generated video, animated video, gif, and audio recording.

19. The computer program product of claim 11, wherein at least one travel experience representation includes at least one tagged item having a tag, and wherein selecting the tag for the at least one tagged item enables purchase of the tagged item.

20. A method, implemented at a computer system that includes one or more processors, of procuring a unique travel package that is tailored to a user's interests, the method comprising:
displaying, at a display device, a visual exploration user interface that includes:
a display of a plurality of first-level experience related images that are configured to invoke an emotional or inspiring influence on a user, each of the plurality of first-level experience related images being associated with at least one second-level experience related image in a plurality of second-level experience related images; and
one or more user input controls that are configured to enable a user selection from among the plurality of first level experience related images;
receiving, at one or more input devices, a first user selection of a first set of one or more of the plurality of first-level experience related images;
based on the first user selection of the first set of first-level experience related images, identifying a second set of one or more second-level experience related images that are relevant to the selected first set of first-level experience related images, the second set of one or more second-level experience related images being a subset of the plurality of second-level experience related images;
receiving, at the one or more input devices, a second user selection from among the second set of one or more second-level experience related images;
based on the first and second user selections, identifying one or more travel destinations of interest to the user;
ranking the one or more travel destinations based on the first and second user selections; and
displaying, at the display device, one or more unique travel packages that correspond to at least one of the one or more travel destinations.
